(19) United States
(12) Patent Application Publication
(10) Pub. No.: US 2018/0056888 A1
(43) Pub. Date: Mar. 1, 2018

(54) MULTI-POSITIONAL DASHBOARD MOUNTING APPARATUS

(71) Applicant: Hong Wang, Staten Island, NY (US)

(72) Inventor: Hong Wang, Staten Island, NY (US)

(21) Appl. No.: 15/360,639

(22) Filed: Nov. 23, 2016

Related U.S. Application Data
(63) Continuation of application No. 15/246,952, filed on Aug. 25, 2016, now abandoned.

(51) Int. Cl. B60R 11/02

(52) U.S. Cl. CPC B60R 11/0241; B60R 2011/0005

(57) ABSTRACT

A multi-positional dashboard mounting apparatus for magnetically mounting an electronic device to in a multitude of positions or locations on a dashboard of a vehicle. The apparatus utilizes a pair of magnetic plates at the termini to enable detachable attachment to a metal region of the dashboard and a metal region of the electronic device. A first magnetic plate magnetically engages a metal region of the dashboard. A second magnetic plate magnetically engages a metal region of the electronic device. The apparatus utilizes a unique ball joint mechanism that enables pivotal articulation of the electronic device in multiple directions, up to 180°, and from both ends of apparatus. Because both the first and second ball socket joints pivotally articulate up to 360°, the portable electronic device that is attached to the second magnetic panel pivotally articulates up to 360° relative to the first magnetic panel fixedly attached to the dashboard.

This application is a continuation of U.S. patent application Ser. No. 15/246,952 filed on Aug. 25, 2016.

### FIELD OF THE INVENTION

The present invention relates generally to a multi-positional dashboard mounting apparatus for magnetically mounting a portable electronic device to a dashboard. More so, the present invention relates to a mounting apparatus that holds a portable electronic device in a multitude of positions or locations on a dashboard of a vehicle, and that uses a pair of magnets that attach to a metal region of the dashboard and the portable electronic device, respectively.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Typically, a portable electronic device is a hand-held or wearable device used for communicating and transmitting signals. For example, the walkie-talkie is a portable electronic device that is hand-held when in use, and wearable when not in use. In another example, a smartphone is carried, or worn, on a belt, or in a pocket for easy access to communicate. Often, portable electronic devices are used while driving, or even developed specifically for use in vehicles. The portable electronic devices may be placed on vehicle dashboards and powered, either directly or indirectly, via the vehicle cigarette lighter.

It is known in the art that mounting assemblies are used to mount the portable electronic device to the dashboard of a vehicle. Typically these mounting assemblies include a bracket having feet which fit against the dashboard of the automobile and are held to the dashboard. Attached to the bracket is for instance a ball of a ball and socket joint. The socket of the ball and socket joint is attached thereto. A holster, or other type of container, is attached to the socket for holding for instance the portable electronic device. One such product is a relatively simple bracket whose feet fit into the seams in the dashboard. This has the advantage of requiring no fasteners, but the disadvantage that since it fits in the dashboard seams, a different bracket is required for each model of vehicle, there being no standard distance between dashboard seams. Other types of fasteners actually fasten into the dashboard for instance by screws, etc.

In other mounting means, the portable electronic device attaches to the ventilation grills typically mounted in the dashboard. These grills provide a number of vent ribs to which portable electronic device can be relatively easily clamped or mounted. Hence this is a ready-made mounting area. In one such device, hooks are provided which hook around the vent ribs and a corresponding screw mechanism draws the hooks against the vent ribs. This has several disadvantages. For one thing, there is no assurance that the screw end will actually clear the ribs; also the device may not fit all vehicles.

Yet another type of mounting assembly for use with portable electronic devices is a metal clip which clamps onto the vent ribs and stabilizer legs which bear on the dashboard surrounding the ventilation grill. This type of mounting assembly, however, is not rigidly mounted. It has the advantage of being extremely adjustable, but may come loose under severe vibration. Another mounting assembly is a vent hanging bracket which includes hooks which catch on the vent ribs and a metal clip which presses against the vent, creating a snug fit. Corresponding posts mount on the dashboard. This is self-adjusting and compliant, but provides no width adjustment.

Other proposals have involved systems and methods for mounting portable electronic devices in vehicles. The problem with these mounting assemblies is that they are not adaptable to different types of dashboards and they are not flexible, so as to manipulate the portable electronic device at a desired orientation with one hand. Even though the above cited gripping devices meets some of the needs of the market, a multi-positional dashboard mounting apparatus for magnetically mounting a portable electronic device to in a multitude of positions or locations on a dashboard of a vehicle is still desired.

### SUMMARY

Illustrative embodiments of the disclosure are generally directed to a multi-positional dashboard mounting apparatus for magnetically mounting a portable electronic device to a dashboard. In some embodiments, the multi-positional dashboard mounting apparatus may be configured to hold a portable electronic device in a multitude of positions or locations on a dashboard of a vehicle. The apparatus utilizes a pair of magnetic plates at the termini to enable detachable attachment to a metal region of the dashboard and a metal region of the portable electronic device. The apparatus utilizes a unique ball joint mechanism that enables pivotal articulation of the portable electronic device in multiple directions, up to 180°, and from both ends of the apparatus. The apparatus is effective in holding the portable electronic device on the dashboard of a vehicle, at or below the user's eye level at a typical distance of 1 to 2 feet. In this manner, the user does not have to use the hands to interact with the portable communication device. The apparatus may also be utilized on any metal surface, and can be disposed in a vertical, horizontal, and sloped orientation.

In one aspect, a multi-positional dashboard mounting apparatus, comprises:

a first ball socket joint defined by a first ball and a first ball receptacle, the first ball configured to rotatably articulate in the first ball receptacle;
a first housing configured to at least partially encapsulate the first ball socket joint;
a first magnetic panel configured to generate a magnetic field;
a first shaft configured to extend between the first ball and the first magnetic panel;
whereby the first ball is configured to pivotally articulate up to 360 degrees relative to the first magnetic panel;
a second ball socket joint defined by a second ball and a second ball receptacle, the second ball configured to rotatably articulate in the second ball receptacle;
a second housing configured to at least partially encapsulate the second ball socket joint, the second housing further configured to join with the first housing;
a second magnetic panel configured to generate a magnetic field;
a second shaft configured to extend between the second ball and the second magnetic panel;
whereby the second ball is configured to pivotally articulate up to 360 degrees relative to the second magnetic panel; and
whereby the first ball socket joint is configured to pivotally articulate up to 360 degrees relative to the second ball socket joint.

In another aspect, the first magnetic panel is configured to detachably attach to a metal region of a dashboard.

In another aspect, the metal region of the dashboard comprises a first metal plate.

In another aspect, the second magnetic panel is configured to detachably attach to a metal region of a portable electronic device.

In another aspect, the metal region of the portable electronic device comprises a second metal plate.

In another aspect, the first housing and the second housing have a generally barrel shape.

In another aspect, the first housing has an outer threaded portion.

In another aspect, the second housing has an inner threaded portion configured to rotatably engage the outer threaded portion of the first housing.

In another aspect, the first shaft and the second shaft are threaded screws.

In another aspect, the apparatus further comprises a central cylinder defined by a plurality of spokes, the central cylinder disposed between the first ball receptacle and the second ball receptacle.

In another aspect, the plurality of spokes is configured to enable an incremental pivotal articulation of the first ball and the second ball.

In another aspect, the apparatus further comprises a first washer defined by a first hole configured to enable passage of the first shaft.

In another aspect, the apparatus further comprises a first housing cap, the first housing cap configured to mate with the first housing.

In another aspect, the apparatus further comprises a plurality of first bearings disposed between the first housing cap and the first washer, the plurality of first bearings configured to enable generally uniform pivotal articulation of the first ball and the second ball.

In another aspect, the pluralities of first bearings have a substantially metal fabrication configured to magnetically engage the first magnetic plate.

In another aspect, the apparatus further comprises a second washer defined by a second hole configured to enable passage of the second shaft.

In another aspect, the apparatus further comprises a second housing cap, the second housing cap configured to mate with the second housing.

In another aspect, the apparatus further comprises a plurality of second bearings disposed between the second housing cap and the second washer, the plurality of second bearings configured to enable generally uniform pivotal articulation of the second ball and the second ball.

In another aspect, the plurality of second bearings has a substantially metal fabrication configured to magnetically engage the second magnetic plate.

One objective of the present invention is to detachably mount a portable electronic device to a dashboard of a vehicle.

Another objective is to utilize magnetic fields to detach the portable electronic device to a dashboard.

Yet another objective is to enable pivotal articulation of the portable electronic device relative to the dashboard.

Yet another objective is to enable incremental articulation of the portable electronic device, up to 360°.

Yet another objective is to utilize the apparatus on any metal surface outside the vehicle.

Yet another objective is to stand the apparatus upright or in a horizontal disposition.

Yet another objective is to improve the power output of the portable electronic device by positioning an antenna of the portable electronic device near the windshield.

Yet another objective is to provide an inexpensive to manufacture multi-positional dashboard mounting apparatus for adjustably retaining a portable electronic device to a dashboard of a vehicle.

Other systems, devices, methods, features, and advantages will be or become apparent to one with skill in the art upon examination of the following drawings and detailed description. It is intended that all such additional systems, methods, features, and advantages be included within this description, be within the scope of the present disclosure, and be protected by the accompanying claims and drawings.

### BRIEF DESCRIPTION OF THE DRAWINGS

The invention will now be described, by way of example, with reference to the accompanying drawings, in which:

FIG. 1 illustrates a frontal view of an exemplary portable electronic device attached to a forward facing section of a dashboard through an exemplary multi-positional dashboard mounting apparatus, in accordance with an embodiment of the present invention;

FIG. 2 illustrates a frontal view of the portable electronic device shown FIG. 1 attached to an upward facing section of a dashboard through a multi-positional dashboard mounting apparatus, in accordance with an embodiment of the present invention;

FIG. 3 illustrates a close up right side view of the multi-positional dashboard mounting apparatus between the dashboard and the portable electronic device, in accordance with an embodiment of the present invention;

FIG. 4 illustrates a close up vertical view of the multi-positional dashboard mounting apparatus between the dashboard and the portable electronic device, in accordance with an embodiment of the present invention;

FIG. 5 illustrates a perspective view of the multi-positional dashboard mounting apparatus, in accordance with an embodiment of the present invention;

FIG. 6 illustrates a blow up elevated side view of the multi-positional dashboard mounting apparatus, in accordance with an embodiment of the present invention; and

FIG. 7 illustrates a blow up top angle view of the multi-positional dashboard mounting apparatus, in accordance with an embodiment of the present invention.

Like reference numerals refer to like parts throughout the various views of the drawings.

### DETAILED DESCRIPTION OF THE INVENTION

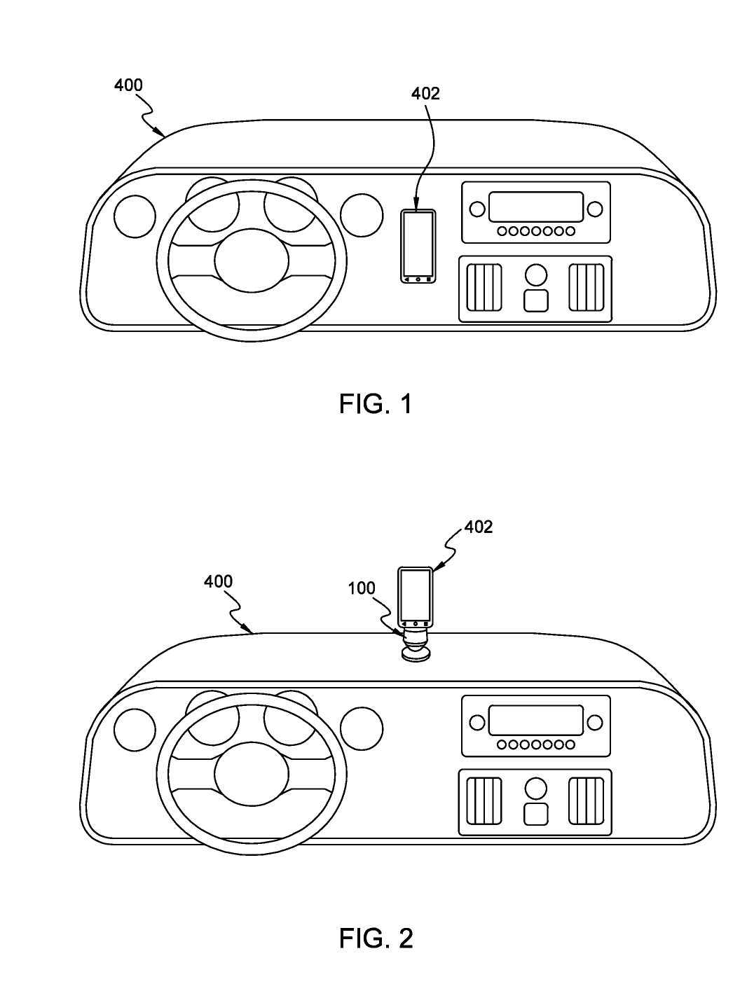

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper,” “lower,” “left,” “rear,” “right,” “front,” “vertical,” “horizontal,” and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Specific dimensions and other physical characteristics relating to the embodiments disclosed herein are therefore not to be considered as limiting, unless the claims expressly state otherwise.

A multi-positional dashboard mounting apparatus 100 is referenced in FIGS. 1-6. The multi-positional dashboard 400 mounting apparatus 100, hereafter “apparatus 100” is configured to magnetically mount a portable electronic device 402 to a dashboard 400 of a vehicle. As illustrated in FIGS. 1 and 2, apparatus 100 may be configured to hold a portable electronic device 402 in a multitude of positions or locations on a metal region of the dashboard 400. Apparatus 100 utilizes a pair of magnetic plates at the termini to enable detachable attachment to a metal region of dashboard 400 and a metal region of portable electronic device 402.

For example, FIG. 1 illustrates a frontal view of portable electronic device 402 attached to a forward facing section of a dashboard 400 through apparatus 100. In this arrangement, apparatus 100 can be adjusted laterally, coplanar with the forward facing section of the dashboard 400 to better operate and view portable electronic device 402. FIG. 2 illustrates a frontal view of the portable electronic device shown FIG. 1 attached to an upward facing section of dashboard 400 through apparatus 100. In this arrangement, the apparatus 100 can be adjusted in any direction and orientation to better operate and view portable electronic device 402.

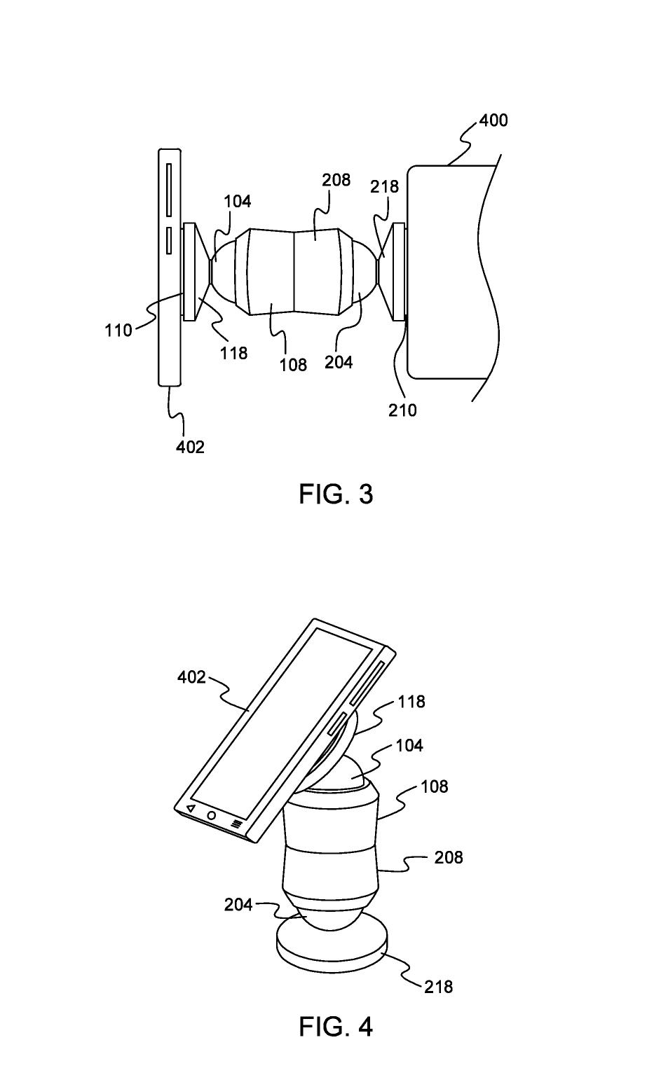

Thus, as FIG. 3 shows, apparatus 100 is sandwiched between dashboard 400 and portable electronic device 402 in a generally horizontal orientation, while enabling adjustable, multi-positional manipulation of the positon of the portable electronic device 402. Similarly, FIG. 4 illustrates apparatus 100 serving as a bridge between dashboard 400 and portable electronic device 402, while disposed in a generally vertical orientation. This vertical orientation enables adjustable, multi-positional manipulation of the positon of the portable electronic device 402 from an upright positon on dashboard 400.

Portable electronic device 402 may include, without limitation, a smartphone, an MP3 player, a video player, a tablet, a PDA, a GPS unit, and an electronic device 402 having a digital display screen that displays images or interacts with the user via software generated buttons. Dashboard 400 may include a control panel placed in front of the driver of an automobile, boat, motorcycle, or airplane housing instrumentation and controls for operation of the vehicle. For operation of apparatus 100, the portable electronic device 402 and dashboard 400 must have a metal region, respectively. The metal region may include a plate that attaches to portable electronic device 402 and dashboard 400, or an integrated portion of metal contained therein.

In one embodiment, apparatus 100 may also support the portable electronic device 402 on a table, a wall, a window, or a generally flat surface having at least partial metallic composition. In this manner, the user does not have to use the hands to interact with the portable communication device. Apparatus 100 may also be utilized on any metal, generally flat surface. Apparatus 100 may be disposed in a vertical or horizontal orientation.

Apparatus 100 is not configured to any particular year or model of automobile or other vehicle, but is adaptable in several different ways so as to provide different attachment configurations. Apparatus 100 is attachable without tools to most automobiles by use of two magnetic plates that magnetically engage two corresponding metal regions of dashboard 400 and portable electronic device 402. This allows apparatus 100 to conform to different sizes and shapes of dashboards and portable electronic devices while maintaining a firm connection.

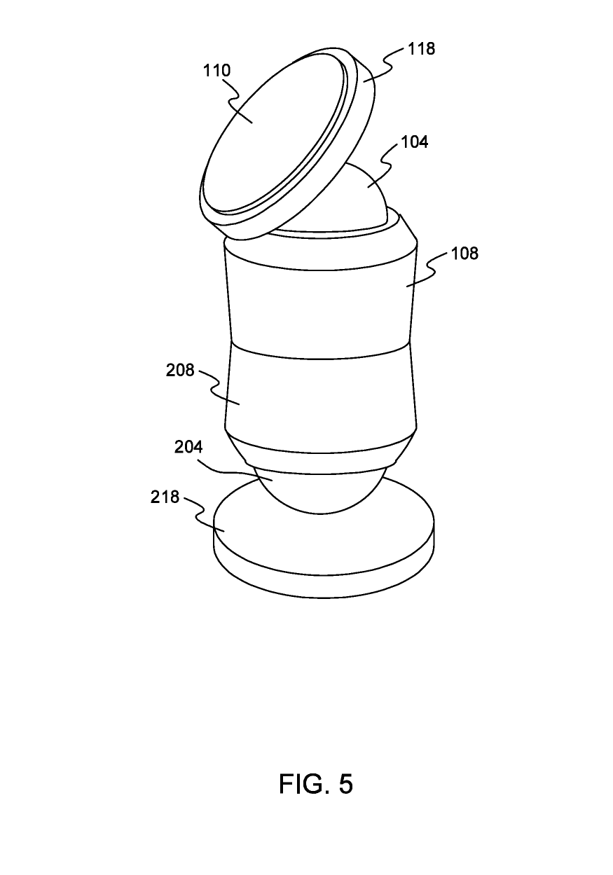

Turning now to FIG. 5, apparatus 100 utilizes a unique ball joint mechanism that enables pivotal articulation of portable electronic device 402 in multiple directions, up to 180°, and from both ends of apparatus 100. In some embodiments, assembly 100 comprises a first ball socket joint 102 defined by a first ball 104 and a first ball receptacle 106. First ball 104 is configured to rotatably articulate in the first ball receptacle 106. First ball 104 rotates freely in multiple directions inside the first ball receptacle 106. First ball 104 may include a generally spherical member that rotates smoothly inside the first ball receptacle 106.

As FIG. 4 references, a first housing 108 at least partially encapsulates the first ball socket joint 102. First housing 108 is configured to protect the first ball socket joint 102 from moisture and physical impact. First housing 108 may have a generally barrel shape. First housing 108 has an outer threaded portion 122 that enables mating with a second housing 208, discussed below.

In some embodiments, apparatus 100 comprises a first magnetic panel 110 at a terminus of the apparatus 100. First magnetic panel 110 is generally flat and rigid. First magnetic panel 110 is configured to generate a magnetic field. The magnetic panel enables magnetic engagement with the metal region of the dashboard 400. First magnetic panel 110 is configured to detachably attach to a first metal region of a dashboard 400. In this manner, the apparatus 100 can detachably attach to the dashboard 400. In some embodiments, the metal region of the dashboard 400 comprises a first metal plate. Though in other embodiments, the metal region is integrated into dashboard 400.

Looking back at FIG. 5, a first shaft 112 extends between the first ball 104 and the first magnetic panel 110. First shaft 112 articulates in corresponding motion with the first ball 104. In this manner, first shaft 112 can articulate up to 360° while carrying first magnetic panel 110. In one possible embodiment, first shaft 112 is a threaded screw.

Apparatus 100 utilizes a mirror replication to enable attachment to the portable electronic device 402. The apparatus 100 comprises a second ball socket joint 202 defined by a second ball 204 and a second ball receptacle 206. Second ball 204 configured to rotatably articulate in the second ball receptacle 206. Second ball 204 rotates freely in multiple directions inside second ball receptacle 206. Second ball 204 may include a generally spherical member that rotates smoothly inside second ball receptacle 206.

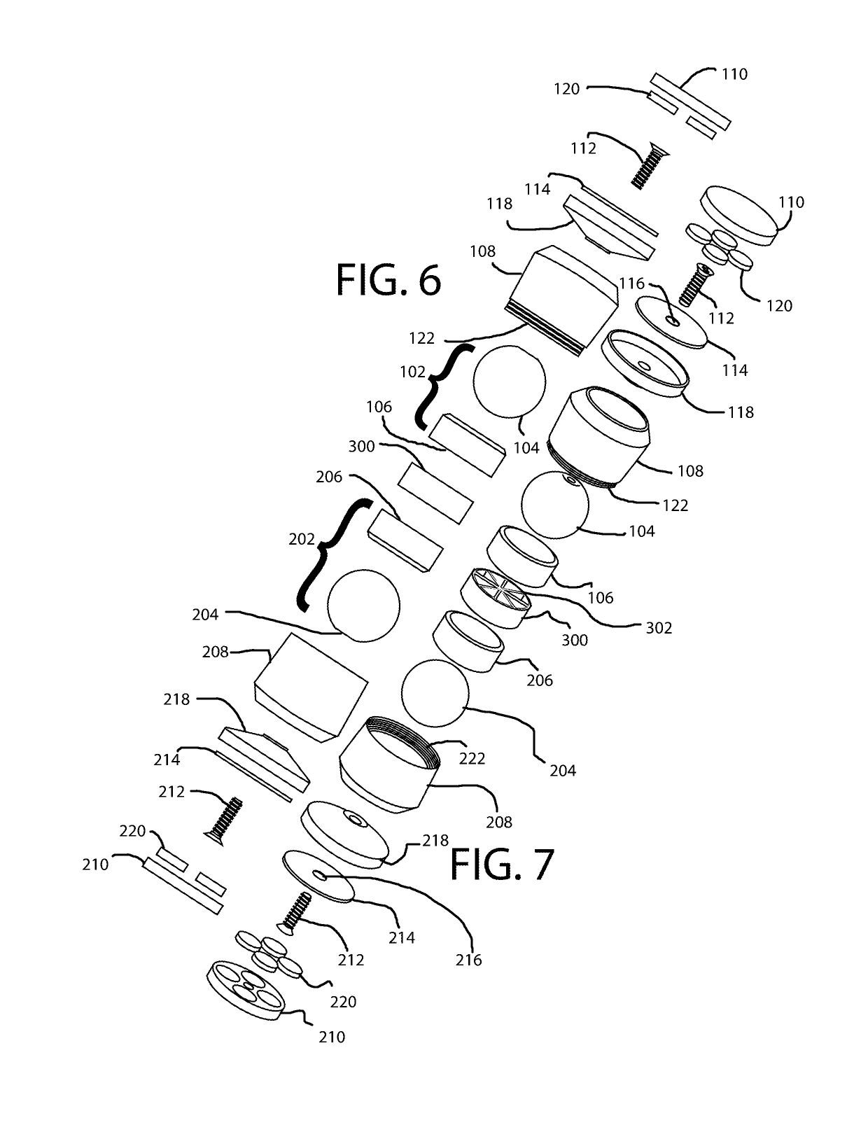

As shown in the blow up view of FIG. 6, apparatus 100 further includes a second housing 208 configured to at least partially encapsulate second ball socket joint 202, and also to join with the first housing 108. In this manner, the first housing 108 and the second housing 208 encapsulate a substantial portion of the apparatus 100 components. Similar to the first housing 108, second housing 208 has a generally barrel shape. Second housing 208 has an inner threaded portion 222 configured to rotatably engage the outer threaded portion 122 of the first housing 108. Thus, the housings 108, 208 can be rotatably separated and mated to access the ball socket joints 102, 202.

In some embodiments, apparatus 100 comprises a second magnetic panel 210 at a terminus of the apparatus 100, opposite the first magnetic panel 110. Second magnetic panel 210 is generally flat and rigid. Second magnetic panel 210 is configured to generate a magnetic field. Second magnetic panel 210 enables magnetic engagement with the second metal region of portable electronic device 402, so as to detachably attach to a metal region of portable electronic device 402.

In this manner, apparatus 100 can detachably attach to the portable electronic device 402. In some embodiments, the metal region of portable electronic device 402 comprises a second metal plate. Though in other embodiments, the metal region is integrated into portable electronic device 402.

Looking at the perspective blow up view of FIG. 7, a second shaft 212 extends between the second ball 204 and the second magnetic panel 210. Second shaft 212 articulates in corresponding motion with the second ball 204. In this manner, second shaft 212 articulate up to 360° while carrying the second magnetic panel 210. Second shaft 212 may include a threaded screw.

Thus, because both first and second ball socket joints 102, 202 can pivotally articulate up to 360 degrees relative to each other, the portable electronic device 402 that is attached to second magnetic panel 210 pivotally articulates up to 360° relative to the first magnetic panel 110 that is fixedly attached to dashboard 400. In this manner, apparatus 100 can hold portable electronic device 402 on the dashboard 400 of a vehicle, at or below the user's eye level at a typical distance of 1 to 2 feet. And the user may view and adjust a screen on portable electronic device 402 with one hand while driving.

In some embodiments, apparatus 100 may further include a central cylinder 300 defined by a plurality of spokes 302. Central cylinder 300 is disposed between first ball receptacle 106 and second ball receptacle 206. The central cylinder 300 has beveled edges that enable mating with the ball receptacles. Spokes 302 are configured to enable an incremental pivotal articulation of first ball 104 and second ball 204. This is because the balls roll over spaces between the spokes 302.

In some embodiments, apparatus 100 further comprises a first washer 114 defined by a first hole 116 configured to enable passage of first shaft 112. First washer 114 creates spacing to enable enhanced articulation of first ball 104 in the first ball receptacle 106. The apparatus 100 further comprises a first housing cap 118 configured to mate with first housing 108. The first housing cap 118 is configured to receive first magnetic panel 110, forming a housing for the magnetic component.

In some embodiments, apparatus 100 may further include a plurality of first bearings 120 disposed between the first housing cap 118 and the first washer 114. First bearings 120 are configured to enable generally uniform pivotal articulation of first ball 104. First bearings 120 have a substantially metal fabrication configured to magnetically engage first magnetic panel 110. In some embodiments, first bearings 120 may be spherical or flat and circle shaped.

Apparatus 100 further comprises a second washer 214 defined by a second hole 216 configured to enable passage of second shaft 212. Second washer 214 creates spacing to enable enhanced articulation of second ball 204 in the second ball receptacle 206. The apparatus 100 further comprises a second housing cap 218 configured to mate with second housing 208. Second housing cap 218 is configured to receive second magnetic panel 210, forming a housing for the magnetic component of apparatus 100.

Looking again at FIG. 6, apparatus 100 may further include a plurality of second bearings 220 disposed between the second housing cap 218 and the second washer 214. Second bearings 220 are configured to enable generally uniform pivotal articulation of the second ball 204. Second bearings 220 have a substantially metal fabrication configured to magnetically engage the second magnetic plate. In some embodiments, second bearings 220 may be spherical or flat and circle shaped.

In operation, first magnetic panel 110 is magnetically engaged with a section of the dashboard 400 having a metal region. Portable electronic device 402 having a metal region is magnetically attached to the second magnetic panel 210. First and second housing 108, 208 are gripped and second magnetic panel 210 is manipulated to a desired orientation relative to the fixed dashboard 400. This may include an angle that can be viewed while driving. FIG. 3 illustrates first magnetic panel 110 and the second magnetic panel 210 oriented at 90° in the same direction.

It is also significant to note that the mounting means of apparatus 100 may be either an aftermarket accessory addition to the vehicle or an option available at the time of purchase to render easy and convenient mounting of portable electronic device 402 without loose wires and providing proper positioning of a video camera built into a smart phone, for example. In one embodiment, portable electronic device 402 is positioned for viewing either through the windshield or backward onto the occupants enabling monitoring accidents between vehicles, the result of an accident on the occupants of the vehicle or for security monitoring of the trespassers within the vehicle. This is accomplished by mounting the portable electronic device 402 at the dashboard 400. Another advantage is to improve the power output of portable electronic device 402 by positioning an antenna of portable electronic device 402 near the windshield.

These and other advantages of the invention will be further understood and appreciated by those skilled in the art by reference to the following written specification, claims and appended drawings.

Because many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalence.

What is claimed is:

1) An apparatus, the apparatus comprising:
a first ball socket joint defined by a first ball and a first ball receptacle, the first ball configured to rotatably articulate in the first ball receptacle;
a first housing configured to at least partially encapsulate the first ball socket joint;
a first magnetic panel configured to generate a magnetic field;
a first shaft configured to extend between the first ball and the first magnetic panel;
whereby the first ball is configured to pivotally articulate up to 360 degrees relative to the first magnetic panel;
a second ball socket joint defined by a second ball and a second ball receptacle, the second ball configured to rotatably articulate in the second ball receptacle;
a second housing configured to at least partially encapsulate the second ball socket joint, the second housing further configured to join with the first housing;
a second magnetic panel configured to generate a magnetic field;
a second shaft configured to extend between the second ball and the second magnetic panel;
whereby the second ball is configured to pivotally articulate up to 360 degrees relative to the second magnetic panel; and
whereby the first ball socket joint is configured to pivotally articulate up to 360 degrees relative to the second ball socket joint.

2) The apparatus of claim 1, wherein the first magnetic panel is configured to detachably attach to a metal region of a dashboard.

3) The apparatus of claim 2, wherein the metal region of the dashboard comprises a first metal plate.

4) The apparatus of claim 3, wherein the second magnetic panel is configured to detachably attach to a metal region of a portable electronic device.

5) The apparatus of claim 4, wherein the metal region of the portable electronic device comprises a second metal plate.

6) The apparatus of claim 5, wherein the first housing and the second housing have a barrel shape and the first magnetic panel is identical to the second magnetic panel to create a symmetrical appearance and reversible function.

7) The apparatus of claim 6, wherein the first housing has an outer threaded portion.

8) The apparatus of claim 7, wherein the second housing has an inner threaded portion configured to rotatably engage the outer threaded portion of the first housing.

9) The apparatus of claim 8, wherein the first shaft and the second shaft are threaded screws.

10) The apparatus of claim 9, further comprising a central cylinder containing a plurality of spokes, the central cylinder disposed between the first ball receptacle and the second ball receptacle.

11) The apparatus of claim 10, wherein the plurality of spokes are configured to enable an incremental pivotal articulation of the first ball and the second ball.

12) The apparatus of claim 11, further comprising a first washer defined by a first hole configured to enable passage of the first shaft.

13) (canceled)

14) (canceled)

15) (canceled)

16) (canceled)

17) (canceled)

18) (canceled)

19) (canceled)

20) An apparatus, the apparatus comprising:
a first ball socket joint defined by a first ball and a first ball receptacle, the first ball configured to rotatably articulate in the first ball receptacle;
a first housing configured to at least partially encapsulate the first ball socket joint;
a first magnetic panel configured to generate a magnetic field;
a first shaft configured to extend between the first ball and the first magnetic panel;
whereby the first ball is configured to pivotally articulate up to 360 degrees relative to the first magnetic panel;
a second ball socket joint defined by a second ball and a second ball receptacle, the second ball configured to rotatably articulate in the second ball receptacle;
a second housing configured to at least partially encapsulate the second ball socket joint, the second housing further configured to join with the first housing;
a second magnetic panel configured to generate a magnetic field;
a second shaft configured to extend between the second ball and the second magnetic panel;
whereby the second ball is configured to pivotally articulate up to 360 degrees relative to the second magnetic panel;
whereby the first ball socket joint is configured to pivotally articulate up to 360 degrees relative to the second ball socket joint;
a central cylinder containing a plurality of spokes, the central cylinder disposed between the first ball receptacle and the second ball receptacle.
